(19) United States
(12) Patent Application Publication
(10) Pub. No.: US 2007/0104167 A1
(43) Pub. Date: May 10, 2007

(54) Signaling cell combining capabilities

(75) Inventors: Masatoshi Nakamata, Kanagawa (JP); Karri Ranta-Aho, Espoo (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/588,187

(22) Filed: Oct. 26, 2006

Related U.S. Application Data
(60) Provisional application No. 60/734,485, filed on Nov. 7, 2005.

(51) Int. Cl. H04Q 7/24

(52) U.S. Cl. 370/338; 370/328

(57) ABSTRACT

The specification and drawings present a new method, system, apparatus and software product for providing combining capability information of a Node B (supporting a cell to which a user equipment is set-up) to radio network controllers as related to HSUPA (High Speed Uplink Packet Access). The Node B can support among others, e.g., incremental redundancy (IR) combining and/or Chase combining. Furthermore, the combining capability information of the node B can be, e.g., for combining data received on an uplink enhanced dedicated channel (E-DCH).

### PRIORITY AND CROSS-REFERENCE TO RELATED APPLICATION

This application claims priority from U.S. Provisional Application Ser. No. 60/734,485, filed on Nov. 7, 2005.

### TECHNICAL FIELD

This invention generally relates to wireless communications and more specifically to providing (signaling) combining capability information of a Node B for a cell to radio network controllers as related to HSUPA (High Speed Uplink Packet Access).

### BACKGROUND ART

An incremental redundancy (IR) combining, utilizing retransmission sequence number (RSN) based redundancy version (RV) index, and a Chase combining (with RV index of zero) have been agreed to use for an uplink enhanced dedicated channel (E-DCH) and originally a Node B would support either one of these two combinings in 3G (Third Generation) mobile wireless communications using a UTRAN (universal mobile telecommunications system (UMTS) terrestrial radio access network). These combining capabilities are normally not known to a serving radio network controller (SRNC) for a user equipment (UE), said SRNC being a controlling RNC (CRNC) supporting the Node B or the SRNC communicating with the Node B using a drifting RNC (DRNC) which supports the Node B during a soft handover (SHO). Then there are cases when a cell (i.e., a Node B supporting this cell) in an E-DCH Active Set for the UE will execute different combining and therefore, a SHO gain will be limited since the UE can use only one combining. The same is applied to a case when the SRNC will indicate which combining the Node B should execute.

Chase combining with HARQ is a scheme wherein if the data packet is not received correctly, the soft symbols are stored (e.g., instead of storing 0s and 1s a probability of whether the bit was 0 or 1 is stored) by the receiver and a retransmission is requested. The transmitter sends the exact same packet again, the receiver combines the soft symbols of the previous transmission attempt(s) with the new transmission before making hard decisions on the symbols (i.e., was it the bit 0 or 1) and attempting to decode the packet.

The Incremental Redundancy (IR) with HARQ is a scheme wherein if the data packet is not received correctly, the packet is stored by the receiver and a retransmission is requested. The transmitter does not send the exact same packet, but additional redundancy bits which are used by the decoder process as additional bits helping the error correction decoder to come up with the correct data packet. In practice the IR schemes are additions to the Chase scheme so that the retransmissions may contain also some bits that had been transmitted earlier.

Typically the IR scheme requires more buffering memory from the receiver as the highest data rates are achieved by transmitting only information bits and very little to no redundancy bits in the initial transmission attempt and thus the subsequent retransmissions contain only additional bits to be stored.

### DISCLOSURE OF THE INVENTION

According to a first aspect of the invention, a method comprises: signaling combining capability information of a Node B for a cell of a wireless communication system to at least one radio network controller.

According further to the first aspect of the invention, the combining capability information may comprise one information element indicating whether the Node B is configured to support for the cell: a) incremental redundancy combining, b) Chase combining or c) both the incremental redundancy and Chase combinings.

According further to the first aspect of the invention, the combining capability information may comprise two information elements, wherein one of the two information elements may indicate whether the Node B is configured to support or not to support incremental redundancy combining for the cell and another of the two information elements may indicate whether the Node B is configured to support or not to support Chase combining for the cell.

Still further according to the first aspect of the invention, the combining capability information may comprise one or more information elements.

According further to the first aspect of the invention, the combining capability information may be for combining data received on an uplink enhanced dedicated channel.

According still further to the first aspect of the invention, the signaling may comprise providing by the Node B the combining capability information of the Node B for the cell to a radio network controller supporting the Node B of the at least one radio network controller. Further, the method of claim 6, wherein the combining capability information may be provided by the Node B to the radio network controller supporting the Node B during a cell set-up for providing a communication with a user equipment. Further still, the providing may be facilitated using a Node B Application Part message signal. Yet still further, the first aspect may comprise storing the combining capability information by the network controller supporting the Node B.

According still further to the first aspect of the invention, the signalling may further comprise: further providing the combining capability information of the Node B for the cell by the radio network controller supporting the Node B to a further radio network controller supporting a further node B of the at least one radio network controller, wherein the further radio network controller is a serving radio network controller. Further, the radio network controller supporting the Node B may be configured as a drift radio network controller for supporting the serving radio network controller for providing a communication with a user equipment during a soft handover of the user equipment from a cell supported by the further Node B to another cell supported by the Node B, and wherein the further providing is performed after the providing in response to the soft handover of the user equipment.

According yet further still to the first aspect of the invention, the signaling may comprise: providing the combining capability information of the Node B for the cell by a radio network controller supporting the Node B to a further radio network controller supporting a further ode B of the at least one radio network controller, wherein the further radio network controller may be a serving radio network controller. Further, the providing may be facilitated using a Radio Network Subsystem Application Part message signal.

According to a second aspect of the invention, a computer program product comprises: a computer readable storage structure embodying computer program code thereon for execution by a computer processor with the computer program code, wherein the computer program code comprises instructions for performing the first aspect of the invention, indicated as being performed by any component or a combination of components of the Node B or the at least one radio network controller.

According to a third aspect of the invention, a network element, comprises: a scheduling module, for providing combining capability information of a Node B for a cell of a communication system to at least one radio network controller.

Further according to the third aspect of the invention, the network element may further comprise: a memory, for storing the combining capability information.

Still further according to the third aspect of the invention, the network element may further comprise: a transmitting module, for transmitting the combining capability information provided by the scheduling module to the at least one network element.

According further to the third aspect of the invention, the combining capability information may comprise one information element indicating whether the Node B is configured to support for the cell: a) incremental redundancy combining, b) Chase combining or c) both the incremental redundancy and Chase combinings.

According still further to the third aspect of the invention, the combining capability information may comprise two information elements, wherein one of the two information elements may indicate whether the Node B is configured to support or not to support incremental redundancy combining for the cell and another of the two information elements may indicate whether the Node B is configured to support or not to support Chase combining for the cell.

According yet further still to the third aspect of the invention, the combining capability information may comprise one or more information elements.

According further still to the third aspect of the invention, the combining capability information may be for combining data received on an uplink enhanced dedicated channel.

Yet still further according to the third aspect of the invention, the network element may be the Node B and the combining capability information of the Node B for the cell may be provided to a radio network controller supporting the Node B of the at least one radio network controller. Further, the combining capability information may be provided to the radio network controller supporting the Node B during a cell set-up for providing a communication with a user equipment. Further still, the providing may be facilitated using a Node B Application Part message signal.

Still yet further according to the third aspect of the invention, the network element may be a radio network controller configured for supporting the Node B and for providing the combining capability information of the Node B for the cell to a further radio network controller supporting a further Node B of the at least one radio network controller, wherein the further radio network controller is a serving radio network controller. Further, the combining capability information of the Node B for the cell may be previously provided to the radio network controller by the Node B. Further still, the providing may be facilitated using a Radio Network Subsystem Application Part message signal. Yet still further, the radio network controller supporting the Node B may be configured as a drift radio network controller for supporting the serving radio network controller for providing a communication with a user equipment during a soft handover of the user equipment from a cell supported by the further Node B to another cell supported by the Node B. Still yet further, an integrated circuit may comprise all or selected blocks or modules of the user equipment.

According to a fourth aspect of the invention, a wireless communication system, comprises: a Node B; and at least one radio network controller, wherein combining capability information of a Node B for a cell is provided to the least one network element.

According further to the fourth aspect of the invention, the Node B may be configured to provide the combining capability information to a radio network controller supporting the Node B of the at least one radio network controller.

Further according to the fourth aspect of the invention, the radio network controller supporting the Node B may be configured to store the combining capability information.

Still further according to the fourth aspect of the invention, the radio network controller supporting the Node B may be further configured to provide the combining capability information of the Node B for the cell to a further radio network controller supporting a further node B of the at least one radio network controller, wherein the further radio network controller may be a serving radio network controller and wherein the combining capability information may be previously provided to the radio network controller by the Node B.

According further to the fourth aspect of the invention, the radio network controller supporting the Node B may be configured as a drift radio network controller for supporting the serving radio network controller for providing a communication with a user equipment during a soft handover of the user equipment from a cell supported by the further Node B to another cell supported by the Node B.

According to a fifth aspect of the invention, a network element, comprises: means for scheduling, for providing combining capability information of a Node B for a cell of a communication system to at least one radio network controller.

According further to the fifth aspect of the invention, the network element may further comprise: means for storing the combining capability information.

### BRIEF DESCRIPTION OF THE DRAWINGS

For a better understanding of the nature and objects of the present invention, reference is made to the following detailed description taken in conjunction with the following drawings, in which:

FIG. 1 is a block diagram showing a user equipment (UE) in a communication with a UTRAN during a cell set-up and/or a soft handover (SHO) for applying various embodiments of the present invention;

FIG. 2 is a block diagram illustrating signaling combining capability information of a Node B of a wireless communication system to one or more radio network controllers, according to an embodiment of the present invention; and

FIG. 3 is a flow chart demonstrating signaling combining capability information of a Node B of a wireless communication system to one or more radio network controllers, according to an embodiment of the present invention.

### MODES FOR CARRYING OUT THE INVENTION

A new method, system, apparatus and software product are presented for providing (signaling) combining capability information of a Node B (supporting a cell to which a user equipment is set-up) to radio network controllers as related to HSUPA (High Speed Uplink Packet Access), e.g., for FDD (frequency division duplex) capabilities. The Node B can support among others, e.g., incremental redundancy (IR) combining and/or Chase combining. Furthermore, the combining capability information of the Node B can be, e.g., for combining data received on an uplink enhanced dedicated channel (E-DCH).

In general, the combining capability information can comprise one or more information elements. According to one embodiment of the present invention, this combining capability information of the node B can comprise one information element indicating whether the node B is configured to support: a) the IR combining, b) the Chase combining or c) both the IR and the Chase combining. According to another embodiment of the present invention, this combining capability information of the Node B can comprise two information elements indicating as follows: one of the two information elements indicating whether the node B is configured to support the IR combining or not, and another of said two information elements indicating whether the node B is configured to support the Chase combining or not.

According to further embodiment of the present invention, the Node B can provide the combining capability information of the Node B to a controlling radio network controller (CRNC), e.g., during a cell set-up for providing a communication with a user equipment (UE). This signalling can occur, for example, during an initial cell set-up, wherein necessary configurations for a cell are setup and other capability information (e.g. HSDPA capability) are provided from the Node B to the CRNC. The signalling from the Node B to the CRNC, according to an embodiment of the present invention, can be provided using a Node B Application Part (NBAP) message signal over an Iub interface. It is noted that the combining capability information can be typically stored in a memory of the Node B and/or in a memory of the CRNC.

According to a further embodiment of the present invention, the signaling of the combining capability information of the Node B can be further provided, or independently provided by the CRNC supporting said Node B (the combining capability information can be provided by the Node B, can be stored in the memory of the CNRC after being provided by the Node B as described above, or it can be independently provided through Operation and Maintenance (O&M)) to a further RNC supporting a further Node B, wherein said further RNC functions, e.g., as a serving RNC (SRNC). This further providing of the combining capability information from the CRNC to the SRNC can follow the initial providing from the Node B to the CRNC during, e.g., the SHO or can be an independent step. Moreover, it is noted that during said further providing of the combining capability information of the Node B, the CRNC is configured as a drift radio network controller (DRNC) for supporting the SRNC for providing a communication with the UE during the SHO of the UE from a cell supported by the further Node B to another cell supported by said Node B. The signalling from the CRNC (i.e., DRNC) to the SRNC, according to an embodiment of the present invention, can be provided using a Radio Network Subsystem Application Part (RNSAP) message signal over an Iur interface. It is further noted that the combining capability information can be further stored in a memory of the SRNC as well.

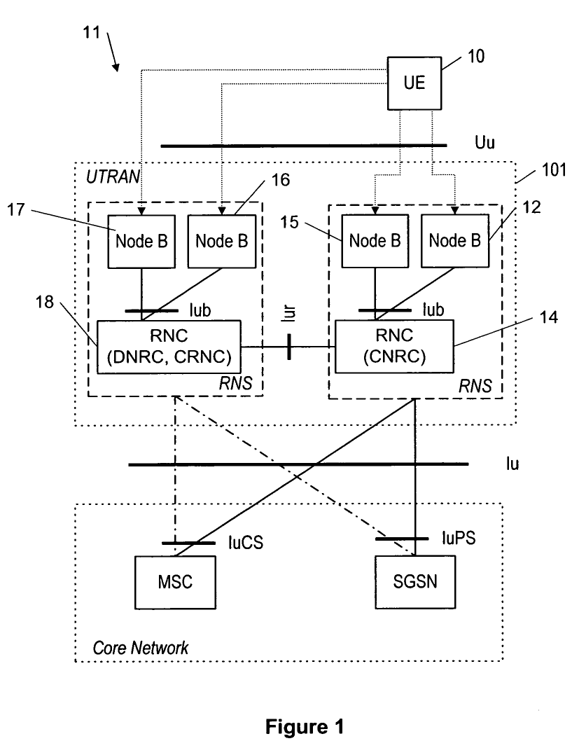

FIG. 1 is an example among others of a block diagram showing a user equipment (UE) 10 in communication with an UTRAN (universal mobile telecommunications system (UMTS) terrestrial radio access network) 101 of a wireless communication system 11 during a cell setup and/or a soft handover (SHO) for applying various embodiments of the present invention.

As shown in FIG. 1, according to 3G WCDMA (Third Generation Wideband Code Division Multiple Access), in communicating via wireless communication, the user equipment (UE) 10 can interface with UTRAN Node Bs (also sometimes called a base station) 12, 15, 16 and 17 over a so-called Uu interface. The UTRAN Node B12, 15, 16 or 17 in turn can communicate with a UTRAN radio network controller (RNC) 14 or 18, respectively, over a so-called Iub interface, and the RNC can communicate with a core network (CN) entity, either a mobile switching center (MSC) or a serving GPRS (general packet radio system) support node (SGSN), over a so-called Iu interface, and also can communicate with other RNCs over a so-called Iur interface. The Iu interface is more specifically either an Iu circuit-switched interface IuCS between a UTRAN RNC and an MSC, or an Iu packet-switched interface IuPS between a UTRAN RNC and an SGSN. The user equipment 10 can be a wireless device, a portable device, a mobile communication device, a mobile phone, etc.

The user equipment 10 can undergo the SHO from a cell supported by the Node B 12 to another cell supported by the Node B 15, wherein both Node Bs 12 and 15 are supported by the RNC (or controlling NRC) 14. Alternatively, the user equipment 10 can undergo SHO from a cell supported by the Node B 12 to another cell supported by the Node B 16 or 17 which is supported by another RNC (or controlling NRC) 18. Both situations are considered by various embodiments of the present invention described herein.

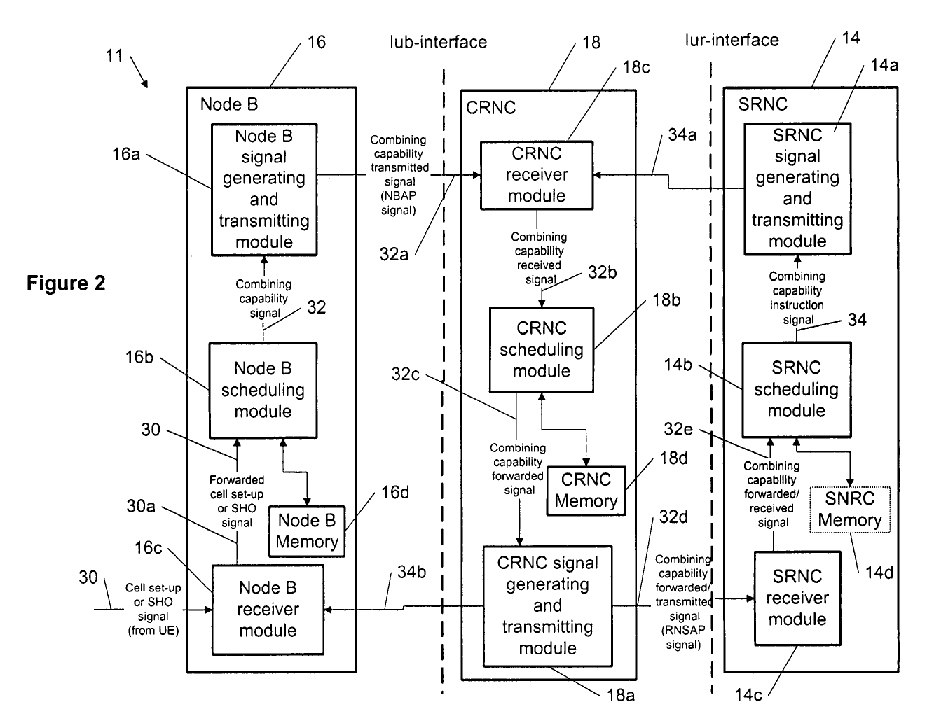

FIG. 2 shows a detailed example among others of a block diagram illustrating signaling combining capability information of the Node B 16 of a wireless communication system 11 to one or more radio network controllers 18 and 14, according to an embodiment of the present invention.

In the example of FIG. 1, the Node B 16 comprises a Node B uplink signal generating and transmitting module 16a, a Node B scheduling module 16b, a Node B receiver module 16c and a Node B memory 16d. The RNC (or CRNC) 18 comprises a CRNC uplink signal generating and transmitting module 16a, a CRNC scheduling module 18b, a CRNC receiver module 18c and a CRNC memory 18d. Finally, as shown, the RNC (or SRNC) 14 comprises an SRNC uplink signal generating and transmitting module 14a, an SRNC scheduling module 14b, an SRNC receiver module 14c and a SRNC memory 14d.

Upon receiving a cell set-up 30 by the Node B receiver module 16c which is forwarded as a signal 30, the Node B scheduling module 16b generates, according to embodiments described herein, a combining capability signal 32 comprising Node B 16 combining capability information retrieved, e.g., from the Node B memory 16d. The signal 32 is re-transmitted as a signal 32a (e.g., an NBAP signal) by the module 16a to the CRNC receiver module 18c of the CRNC 18, wherein the signal 32a being provided as a signal 32b to the CRNC scheduling module 18b and to the CRNC memory 18d. This is a first step of providing the combining capability information of the Node B to the controlling RNC. If the CRNC 18 is also the SRNC for the user equipment linked to the Node B 16 during the SHO (e.g., from the Node B 17 to the Node B 16), then no further signaling regarding Node B combining capabilities is required and the CRNC scheduling module 18b can generate a combining capability instruction (not shown in FIG. 2) for the Node B 16 defining the combining capability to be used based on the received information regarding combining capabilities of the Node B 16, e.g., for combining the data received on an uplink enhanced dedicated channel (E-DCH).

However, if the CRNC 18 is not the SNRC for the user equipment radio linked to the Node B 16 during, e.g., the SHO from the Node B 15 to the Node B 16 (see FIG. 1), then the CRNC scheduling module 18b can generate, according to embodiments described herein, a combining capability forwarding signal 32c comprising the Node B 16 combining capability information, e.g., retrieved from the CRNC memory 18d (as mentioned above, the signal 32c can be independent from the signaling from the Node B 16 or it can follow that signaling). The signal 32c is retransmitted as a signal 32d (e.g., an RNSAP signal) by the module 18a to the SRNC receiver module 14c of the SRNC 14, wherein the signal 32d being provided as a signal 32e to the SRNC scheduling module 14b and optionally to the SRNC memory 14d. This is a second step of providing the combining capability information of the Node B to the serving RNC which can be performed independently or in conjunction with the first step using various embodiments of the present invention described herein. Then the SRNC scheduling module 14b can generate a combining capability instruction for the Node B 16 defining the combining capability to be used for communicating with the UE based in the received information regarding combining capabilities of the Node B 16 (see signals 34, 34a and 34b), e.g., for combining data received on an uplink enhanced dedicated channel (E-DCH).

According to embodiments of the present invention, the module 16b, 18b or 14b can be implemented as software, hardware block or a combination thereof. Furthermore, each of the blocks 16b, 18b or 14b can be implemented as a separate block or can be combined with any other standard block of the corresponding network element 16, 18 or 14, or it can be split into several blocks according to their functionality. The same is applied to modules 16a, 16c, 16d, 18a, 18c, 18d, 14a, 14c and 14d. All or selected modules of the network element 16, 18 or 14 can be implemented using an integrated circuit.

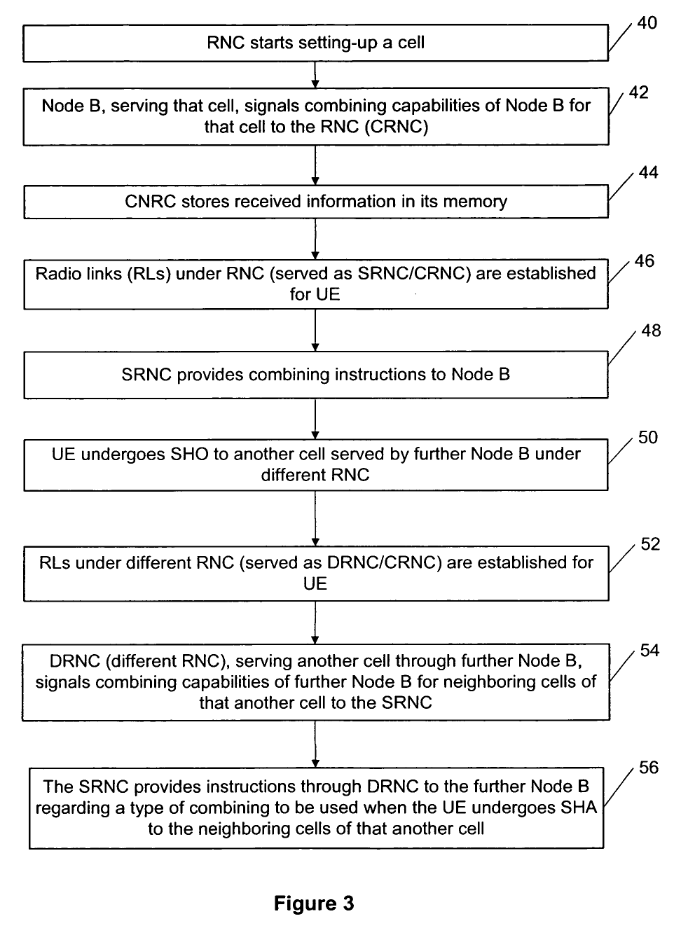

FIG. 3 is a flow chart demonstrating signaling combining capability information of a Node B of a wireless communication system to one or more radio network controllers, according to an embodiment of the present invention.

The flow chart of FIG. 3 only represents one possible scenario among others. The order of steps shown in FIG. 3 is not absolutely required, so generally, the various steps can be performed out of order. In a method according to the first embodiment of the present invention, in a first step 40, an RNC starts setting-up a cell (along with setting-up other cells for the RNC). In a next step 42, a Node B, serving that cell, signals its combining capabilities for that cell to the RNC which is the controlling RNC (CRNC) for the Node B. In a next step 44, the CNRC stores received information in its memory. Then in a next step 46, radio links (RLs) under the RNC/CRNC served as the SRNC/CRNC are established for a user equipment (UE). In response, in a next step 48, the SRNC provides combining instructions to the Node B.

In a next step 50, the UE undergoes a soft handover (SHO) to another cell served by a further Node B under different RNC to which the further Node B, serving said another cell signaled combining capability of the further Node B for said another cell, when the another cell was setup.

In a next step 52, RLs under different RNC (served as DRNC/CRNC) are established for the UE. In a next step 54, the RNC/DRNC, serving said another cell through the further Node B, signals combining capabilities of the further Node B for the neighboring cells of that another cell to the SRNC (the RNC that serving the cell through the Node B). Finally, in a step 56, the SRNC uses the information for providing instructions through the DRNC to the further Node B regarding a type of combining to be used for, e.g., combining the data received on an uplink enhanced dedicated channel (E-DCH) when the UE undergoes a soft handover to the neighboring cells of said another cell.

Tables 1 and 2 demonstrate examples for implementing embodiments of the present invention. Table 1 presents a standardization example, according to one embodiment of the present invention, introduced in 3GPP TS25 TS25.433 v. 6.9.0, Chapter 9.2.2.13X by introducing one IEs shown in “IE Type and Reference” column for defining the E-DCH HARQ Combining capability for a Local Cell in NBAP message which corresponds to step one for signaling combining capability information, described herein.

TABLE 1

| IE/Group | Pres- | | IE Type and | Semantics |
|---|---|---|---|---|
| Name | ence | Range | Reference | Description |
| E-DCH HARQ | | | ENUMERATED (IR | |
| Combining | | | Combining Capable, | |
| Capability | | | Chase Combining | |
| | | | Capable, IR and | |
| | | | Chase Combining | |
| | | | Capable) | |

Table 2 presents another standardization example, according to another embodiment of the present invention, introduced in 3GPP TS25 TS25.423 v. 6.9.0, Chapter 9.2.2.D by introducing two information elements (IE) using the Cell Capability Container FDD for indicating which functionalities a cell supports in RNSAP message which corresponds to step two for signaling combining capability information, as described herein. The highlighted text in Table 2 with a larger sized font for 13^{th} and 14^{th} bits in Semantics Description column correspond to these two IEs. The first new IE (13^{th} bit) indicates whether the IR combining is supported or not, and the second IE indicates whether the Chase combining is supported or not. Both of the two IE are introduced into Cell Capability Container FDD IE in RNSAP.

TABLE 2

| | | | IE Type | |
|---|---|---|---|---|
| IE/Group | Pres- | | and | |
| Name | ence | Range | Reference | Semantics Description |
| Cell | | | BIT | Each bit indicates whether a |
| Capability | | | STRING | cell supports a particular |
| Container | | | (32) | functionality or not. The |
| FDD | | | | value 1 of a bit indicates that |
| | | | | the corresponding |
| | | | | functionality is supported in a |
| | | | | cell and value 0 indicates |
| | | | | that the corresponding |
| | | | | functionality is not supported |
| | | | | in a cell. Each bit is defined |
| | | | | as follows. |
| | | | | The first bit: Reserved. |
| | | | | The second bit: Delayed |
| | | | | Activation Support Indicator. |
| | | | | The third bit: HS-DSCH |
| | | | | Support Indicator. |
| | | | | The fourth bit: Reserved. |
| | | | | The fifth bit: F-DPCH |
| | | | | Support Indicator. |
| | | | | The sixth bit: E-DCH Support |
| | | | | Indicator. |
| | | | | The seventh bit: E-DCH |
| | | | | TTI2ms Support Indicator. |
| | | | | The eighth bit: E-DCH |
| | | | | 2sf2 and 2sf4 and all inferior |
| | | | | SFs Support Indicator. |
| | | | | The ninth bit: E-DCH 2sf2 |
| | | | | and all inferior SFs Support |
| | | | | Indicator. |
| | | | | The tenth bit: E-DCH 2sf4 |
| | | | | and all inferior SFs Support |
| | | | | Indicator. |
| | | | | The eleventh bit: E-DCH sf4 |
| | | | | and all inferior SFs Support |
| | | | | Indicator. |
| | | | | The twelveth bit: E-DCH sf8 |
| | | | | and all inferior SFs Support |
| | | | | Indicator. |
| | | | | The thirteenth bit: E-DCH |
| | | | | HARQ IR Combining |
| | | | | Support Indicator. |
| | | | | The fourteenth bit: E-DCH |
| | | | | HARQ Chase Combining |
| | | | | Support Indicator. |
| | | | | Note that undefined bits are |
| | | | | considered as a spare bit |
| | | | | and spare bits shall be set to |
| | | | | 0 by the transmitter and shall |
| | | | | be ignored by the receiver. |
| | | | | Note that Reserved bits are |
| | | | | not considered as a spare |
| | | | | bit. They shall however be |
| | | | | set to 0 by the transmitter |
| | | | | and shall be ignored by the |
| | | | | receiver. |

As explained above, the invention provides both a method and corresponding equipment consisting of various modules providing the functionality for performing the steps of the method. The modules may be implemented as hardware, or may be implemented as software or firmware for execution by a computer processor. In particular, in the case of firmware or software, the invention can be provided as a computer program product including a computer readable storage structure embodying computer program code (i.e., the software or firmware) thereon for execution by the computer processor.

Also, it is noted that various embodiments of the present invention recited herein can be used separately, combined or selectively combined for specific applications.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. A method, comprising:
signaling combining capability information of a Node B for a cell of a wireless communication system to at least one radio network controller.

2. The method of claim 1, wherein said combining capability information comprises one information element indicating whether the Node B is configured to support for said cell: a) incremental redundancy combining, b) Chase combining or c) both said incremental redundancy and Chase combinings.

3. The method of claim 1, wherein said combining capability information comprises two information elements, wherein one of said two information elements indicates whether the Node B is configured to support or not to support incremental redundancy combining for said cell and another of said two information elements indicates whether the Node B is configured to support or not to support Chase combining for said cell.

4. The method of claim 1, wherein said combining capability information comprises one or more information elements.

5. The method of claim 1, wherein said combining capability information is for combining data received on an uplink enhanced dedicated channel.

6. The method of claim 1, wherein said signaling comprises providing by the Node B said combining capability information of the Node B for the cell to a radio network controller supporting said Node B of said at least one radio network controller.

7. The method of claim 6, wherein said combining capability information is provided by said Node B to the radio network controller supporting said Node B during a cell set-up for providing a communication with a user equipment.

8. The method of claim 6, wherein said providing is facilitated using a Node B Application Part message signal.

9. The method of claim 6, further comprising:
storing said combining capability information by said network controller supporting said Node B.

10. The method of claim 6, wherein said signaling further comprising:
further providing said combining capability information of the Node B for the cell by the radio network controller supporting said Node B to a further radio network controller supporting a further node B of said at least one radio network controller, wherein said further radio network controller is a serving radio network controller.

11. The method of claim 10, wherein said radio network controller supporting said Node B is configured as a drift radio network controller for supporting said serving radio network controller for providing a communication with a user equipment during a soft handover of said user equipment from a cell supported by said further Node B to another cell supported by said Node B, and wherein said further providing is performed after said providing in response to said soft handover of said user equipment.

12. The method of claim 1, wherein said signaling comprising:
providing said combining capability information of the Node B for the cell by a radio network controller supporting said Node B to a further radio network controller supporting a further node B of said at least one radio network controller, wherein said further radio network controller is a serving radio network controller.

13. The method of claim 12, wherein said providing is facilitated using a Radio Network Subsystem Application Part message signal.

14. A computer program product comprising: a computer readable storage structure embodying computer program code thereon for execution by a computer processor with said computer program code, wherein said computer program code comprises instructions for performing the method of claim 1, indicated as being performed by any component or a combination of components of said Node B or said at least one radio network controller.

15. A network element, comprising:
a scheduling module, for providing combining capability information of a Node B for a cell of a communication system to at least one radio network controller.

16. The network element of claim 15, further comprising:
a memory, for storing said combining capability information.

17. The network element of claim 15, further comprising:
a transmitting module, for transmitting said combining capability information provided by said scheduling module to said at least one network element.

18. The network element of claim 15, wherein said combining capability information comprises one information element indicating whether the Node B is configured to support for said cell: a) incremental redundancy combining, b) Chase combining or c) both said incremental redundancy and Chase combinings.

19. The network element of claim 15, wherein said combining capability information comprises two information elements, wherein one of said two information elements indicates whether the Node B is configured to support or not to support incremental redundancy combining for said cell and another of said two information elements indicates whether the Node B is configured to support or not to support Chase combining for said cell.

20. The network element of claim 15, wherein said combining capability information comprises one or more information elements.

21. The network element of claim 15, wherein said combining capability information is for combining data received on an uplink enhanced dedicated channel.

22. The network element of claim 15, wherein said network element is the Node B and said combining capability information of the Node B for the cell is provided to a radio network controller supporting said Node B of said at least one radio network controller.

23. The network element of claim 22, wherein said combining capability information is provided to the radio network controller supporting said Node B during a cell set-up for providing a communication with a user equipment.

24. The network element of claim 22, wherein said providing is facilitated using a Node B Application Part message signal.

25. The network element of claim 22, wherein said network element is a radio network controller configured for supporting said Node B, and for providing said combining capability information of the Node B for the cell to a further radio network controller supporting a further Node B of said at least one radio network controller, wherein said further radio network controller is a serving radio network controller.

26. The network element of claim 25, wherein said combining capability information of the Node B for the cell was previously provided to said radio network controller by said Node B.

27. The network element of claim 25, wherein said providing is facilitated using a Radio Network Subsystem Application Part message signal.

28. The network element of claim 25, wherein said radio network controller supporting said Node B is configured as a drift radio network controller for supporting said serving radio network controller for providing a communication with a user equipment during a soft handover of said user equipment from a cell supported by said further Node B to another cell supported by said Node B.

29. The network element of claim 15, wherein an integrated circuit comprises all or selected blocks or modules of said user equipment.

30. A wireless communication system, comprising:
a Node B; and
at least one radio network controller,
wherein combining capability information of a Node B for a cell is provided to said least one network element.

31. The system of claim 30, wherein said Node B is configured to provide said combining capability information to a radio network controller supporting said Node B of said at least one radio network controller.

32. The system of claim 31, wherein said radio network controller supporting said Node B is configured to store said combining capability information.

33. The system of claim 31, wherein said radio network controller supporting said Node B is further configured to provide said combining capability information of the Node B for the cell to a further radio network controller supporting a further node B of said at least one radio network controller, wherein said further radio network controller is a serving radio network controller and wherein said combining capability information was previously provided to said radio network controller by said Node B.

34. The system of claim 33, wherein said radio network controller supporting said Node B is configured as a drift radio network controller for supporting said serving radio network controller for providing a communication with a user equipment during a soft handover of said user equipment from a cell supported by said further Node B to another cell supported by said Node B.

35. A network element, comprising:
means for scheduling, for providing combining capability information of a Node B for a cell of a communication system to at least one radio network controller.

36. The network element of claim 35, further comprising:
means for storing said combining capability information.
